(19) United States
(12) Patent Application Publication
(10) Pub. No.: US 2012/0291300 A1
(43) Pub. Date: Nov. 22, 2012

(54) AIR DRYING APPARATUS

(75) Inventors: JUN-KAI WANG, Shindian (TW); YING-SHU CHEN, Shindian (TW); XIAO-GANG ZHANG, Shenzhen City (CN); BING YU, Shenzhen City (CN)

(73) Assignees: FIH (HONG KONG) LIMITED, Kowloon (HK); SHENZHEN FUTAIHONG PRECISION INDUSTRY CO., LTD., ShenZhen City (CN)

(21) Appl. No.: 13/284,691

(22) Filed: Oct. 28, 2011

(30) Foreign Application Priority Data
May 20, 2011 (CN) 201110131681.1

(51) Int. Cl. F26B 5/00; F26B 21/02; F26B 19/00

(52) U.S. Cl. 34/90

(57) ABSTRACT

An air drying apparatus includes a main body, a work cabinet, a first air blower and a second blower. The work cabinet includes a plurality of air knives. The first air blower and the second air blower are connected to the work cabinet through a number of pipes, and the power of the first air blower is higher than the second air blower.

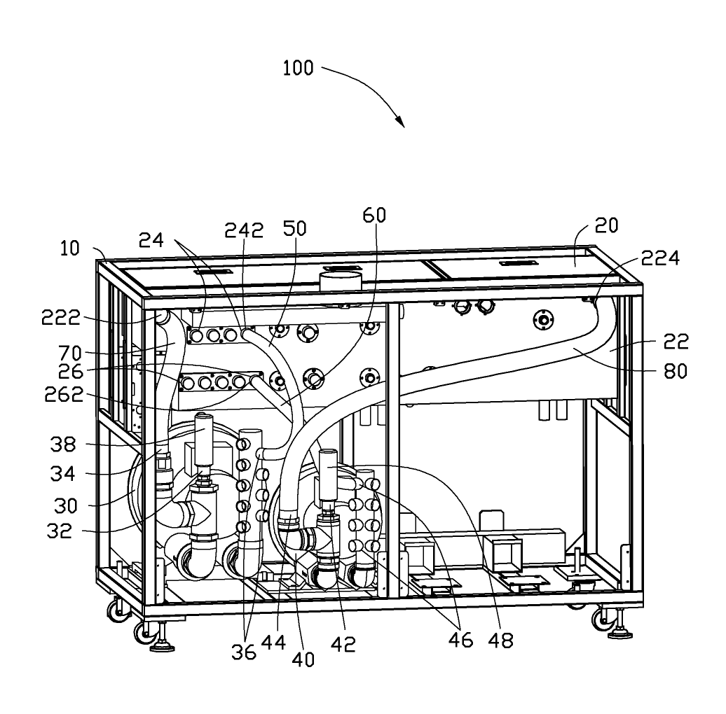

### CROSS-REFERENCE TO RELATED APPLICATIONS

This application is one of the four related co-pending U.S. patent applications listed below. All listed applications have the same assignee and were concurrently filed herewith. The disclosure of each of the listed applications is incorporated by reference into all the other listed applications.

| Attorney | | |
|---|---|---|
| Docket No. | Title | Inventors |
| US39180 | AIR KNIFE MODULE | Chen et al. |
| US39181 | NOZZLE ASSEMBLY FOR SPRAY | Chen et al. |
| | APPARATUS | |
| US39182 | AIR DRYING APPARATUS | Chen et al. |
| US39183 | CLEANING AND DRYING APPARATUS | Chen et al. |

### BACKGROUND

1. Technical Field

The present disclosure generally relates to an air drying apparatus, and particularly to an air drying apparatus which more effectively utilizes energy.

2. Description of Related Art

A type of air drying apparatus includes air knifes positioned opposite to each other. When the air knives eject pressurized air to two sides of objects traveling past on conveyor belts, the objects can be overturned or even blown off the conveyor belt. In addition, the air ejected by the air knives is not recycle, which is wasteful.

Therefore, there is room for improvement within the art.

### BRIEF DESCRIPTION OF THE DRAWINGS

Many aspects of the air drying apparatus can be better understood with reference to the following drawings. The components in the drawings are not necessarily to scale, the emphasis instead being placed upon clearly illustrating the air drying apparatus. Moreover, in the drawings, like reference numerals designate corresponding parts throughout the several views.

The FIGURE is a schematic view of an air drying apparatus according to an exemplary embodiment.

### DETAILED DESCRIPTION

The FIGURE shows an exemplary embodiment of an air drying apparatus 100. The air drying apparatus 100 includes a work cabinet 20, a first air blower 30 and a second air blower 40 mounted in a main body 10. The first air blower 30 and the second air blower 40 are connected to the work cabinet 20 through a number of pipes. The power of the first air blower 30 is greater than the second air blower 40.

The work cabinet 20 includes two groups of first air knives 24 and two groups of second air knives 26. The two groups of the first air knives 24 are respectively mounted on opposite sidewalls 22. The two groups of the second air knives 26 are respectively mounted on the opposite sidewalls 22. Each group of the second air knives 26 is mounted below each group of the first air knives 24. Each first air knife 24 has a first air inlet 242 connected to the first air blower 30 through a first pipe 50. Each second air knife 26 has a second air inlet 262 connected to the second air blower 40 through a second pipe 60. One of the sidewalls 22 defines a first recycle outlet 222 and a second recycle outlet 224 connected to the first air blower 30 and the second air blower 40 respectively.

The first air blower 30 includes a first fresh air inlet 32, and a first recycle inlet 34 and a number of air outlets 36. A first filter 38 is positioned on the first fresh air inlet 32. The fresh air inlet 32 communicates with the outside air, and the first filter 38 is configured for removing impurities from the outside air. The first recycle inlet 34 is connected to the first recycle outlet 222 of the work cabinet 20 through a first connecting pipe 70. Each first air outlet 36 of the first air blower 30 is connected to the first air inlet 242 through the first pipe 50 for supplying air to the first air knives 24. The second air blower 40 includes a second fresh air inlet 42, and a second recycle inlet 44 and a number of air outlets 46. A second filter 48 is positioned on the second fresh air inlet 42. The second fresh air inlet 42 communicates with the outside air, and the second filter 48 is configured for removing impurities from the outside air. The second recycle inlet 44 is connected to the second recycle outlet 224 of the work cabinet 20 through a second connecting pipe 80. Each air outlet 46 of the second air blower 40 is connected to the second air inlet 262 through the first pipe 60 for supplying the air to the second air knives 26.

In use, the first air blower 30 and the second air blower 40 are turned on. The outside air is drawn through the first filter 38 by the first air blower 30. The first air blower 30 then blows air out the air outlets 36. The air further passes through the first pipes 50 to the first air knives 24. Air in the work cabinet 20 further goes back to the first air blower 30 through the first connecting pipe 70 (i.e., is recycled). When outside air is drawn into the system to some degree by the first air blower 30, the recycled air is mostly used for supplying the work cabinet 20, and the outside air is only used for balancing or supplement for the work cabinet 24. The work principle of the second air blower 40 is similar to the first air blower 30. The second blower 40 blows off the air to the second air knives 26. The objects to be air blown are conveyed between the first air knives 24 and the second air knives 26. Because the power of the first air blower 30 is greater than the second air blower 40, the objects remain steadfast on the conveyors. Additionally, air is continuously recycle to the first and second blowers 30, 40 effectively utilizing energy.

It is to be understood, however, that even through numerous characteristics and advantages of the present disclosure have been set forth in the foregoing description, together with details of the structure and function of the disclosure, the disclosure is illustrative only, and changes may be made in detail, especially in matters of shape, size, and arrangement of parts within the principles of the disclosure to the full extent indicated by the broad general meaning of the terms in which the appended claims are expressed.

What is claimed is:

1. An air drying apparatus comprising:
a main body;
a work cabinet including a plurality of air knives;
a first air blower;
a second blower;
wherein the first air blower and the second air blower are connected to the work cabinet through a number of pipes, the power of the first air blower being higher than the power of the second air blower.

2. The air drying apparatus as claimed in claim 1, wherein the work cabinet includes two groups of first air knives and two groups of second air knives, the two groups of the first air knives are respectively mounted on opposite sides in the work cabinet, the two groups of the second air knives are respectively mounted on opposite sides in the work cabinet, and each group of the second air knives is mounted below each group of first air knives.

3. The air drying apparatus as claimed in claim 2, wherein the work cabinet defines a first recycle outlet and a second recycle outlet connected to the first air blower and the second air blower respectively.

4. The air drying apparatus as claimed in claim 3, wherein the first air blower includes a first recycle inlet, the first recycle inlet is connected to the first recycle outlet of the work cabinet through a first connecting pipe.

5. The air drying apparatus as claimed in claim 4, wherein the second air blower includes a second recycle inlet, the second recycle inlet is connected to the second recycle outlet of the work cabinet through a second connecting pipe.

6. The air drying apparatus as claimed in claim 1, wherein the first air blower includes a first fresh air inlet , a first filter is positioned on the first fresh air inlet, the first fresh air inlet communicates with the outside air, and the first filter is configured for removing impurities from the outside air.

7. The air drying apparatus as claimed in claim 6, wherein the second air blower includes a second fresh air inlet, a second filter is positioned on the second fresh air inlet, the second fresh air inlet communicates with the outside air, and the second filter is configured for removing impurities from the outside air.

8. An air drying apparatus comprising:
a main body;
a work cabinet including a plurality of air knives, a first recycle outlet and a second recycle outlet;
a first air blower including a first recycle inlet, the first recycle inlet connected to the first recycle outlet of the work cabinet;
a second blower including a second recycle inlet, the second recycle inlet connected to the second recycle outlet of the work cabinet;
wherein the first air blower and the second air blower provide air to the air knives, the air ejected by the air knives passes through the first recycle outlet and the second recycle outlet to enter into the first air blower and the second blower.

9. The air drying apparatus as claimed in claim 8, wherein the power of the first air blower is greater than the second air blower.

10. The air drying apparatus as claimed in claim 8, wherein the first air blower includes a first fresh air inlet, a first filter is positioned on the first fresh air inlet, the first fresh air inlet communicates with the outside air, and the first filter is configured for removing impurities from the outside air.

11. The air drying apparatus as claimed in claim 10, wherein the second air blower includes a second fresh air inlet, a second filter is positioned on the second fresh air inlet, the second fresh air inlet communicates with the outside air, and the second filter is configured for removing impurities from the outside air.
